(19) United States
(12) Patent Application Publication
(10) Pub. No.: US 2015/0324033 A1
(43) Pub. Date: Nov. 12, 2015

(54) TOUCH SENSING DEVICE, DISPLAY DEVICE INCLUDING THE SAME, AND METHOD OF SENSING TOUCH

(71) Applicant: SAMSUNG ELECTRONICS CO., LTD., Suwon-si (KR)

(72) Inventors: JIN-BONG KIM, Yongin-si (KR); YOON-KYUNG CHOI, Seoul (KR); CHANG-JU LEE, Suwon-si (KR)

(21) Appl. No.: 14/693,196

(22) Filed: Apr. 22, 2015

(30) Foreign Application Priority Data
May 7, 2014 (KR) 10-2014-0054436

(51) Int. Cl. G06F 3/044

(52) U.S. Cl. CPC G06F 3/044; G06F 2203/04101; G06F 2203/04111

(57) ABSTRACT

A touch sensing device includes a first electrode array, a plurality of second electrodes, and a switching block. The first electrode array includes a plurality of first electrodes. The plurality of second electrodes is disposed apart from the first electrode array in a direction perpendicular to rows and columns of the first electrode array. The switching block electrically connects a first plurality of adjacent electrodes of the plurality of first electrodes with one another when the touch sensing device is in a first mode and connects a second plurality of adjacent first electrodes of the plurality of first electrodes with one another when the touch sensing device is in a second mode.

### CROSS-REFERENCE TO RELATED APPLICATION

This application claims priority under 35 U.S.C. §119 to Korean Patent Application No. 10-2014-0054436, filed on May 7, 2014, in the Korean Intellectual Property Office, and the disclosure of which is incorporated by reference herein in its entirety.

### TECHNICAL FIELD

The present inventive concept relates to a touch sensing device, and more particularly, to a display device including the touch sensing device and a method of sensing a touch.

### DISCUSSION OF THE RELATED ART

A touch sensing device may receive a user's touch input made by a user's finger, a touch pen, or the like, convert information corresponding to a position of the user's touch into an electrical signal, and provide the electrical signal to electronic devices (e.g., a portable phone, a laptop computer, a desktop computer, and a personal digital assistant (PDA)). The electronic devices may recognize the position where the touch occurs based on the electrical signal, analyze the touch position, and perform an operation corresponding to the user's touch input.

For example, the touch sensing device may employ a capacitive method in which the touch position may be determined based on a capacitance variation attributable to the user's touch input.

### SUMMARY

According to an aspect of the present inventive concept, there is provided a touch sensing device. The touch sensing device includes a first electrode array, a plurality of second electrodes, and a switching block. The first electrode array includes a plurality of first electrodes. The plurality of second electrodes is disposed apart from the first electrode array in a direction perpendicular to rows and columns of the first electrode array and arranged in a direction parallel to the rows of the first electrode array. The switching block is configured to receive a control signal indicating a first mode or a second mode, and to electrically connect a first plurality of adjacent first electrodes of the plurality of first electrodes with one another when the control signal indicates the first mode. The first plurality of adjacent first electrodes is disposed in a first row of the first electrode array. The first plurality of adjacent first electrodes overlaps at least one of the plurality of second electrodes.

When the control signal indicates the second mode, the switching block may be configured to electrically connect a second plurality of adjacent first electrodes of the plurality of first electrodes with one another. The second plurality of adjacent first electrodes may be disposed in a first column of the first electrode array.

Each of the plurality of second electrodes may extend in a direction parallel to the columns of the first electrode array.

When the control signal indicates the second mode, the plurality of second electrodes may be floated or a constant voltage may be applied to the plurality of second electrodes.

The switching block may include a first switching unit and a second switching unit. The first switching unit may be configured to connect first electrodes disposed on one side of the first row with one another in response to the control signal. The second switching unit may be configured to connect first electrodes disposed on another side of the first row in response to the control signal. The first and second switching units may be respectively disposed at both ends of the rows of the first electrode array.

When the control signal indicates the first mode, the switching block may be configured to electrically connect all of the first electrodes disposed in the first row of the first electrode array with one another.

The touch sensing device may further include a third electrode disposed apart from the first electrode array in an opposite direction to the plurality of second electrodes. The touch sensing device may sense a touch based on a variation in capacitance between the first plurality of adjacent first electrodes disposed in the first row and the at least one of the plurality of second electrodes when the control signal indicates the first mode. The touch sensing device may sense a touch based on a variation in capacitance between at least one of the plurality of first electrodes and the third electrode when the control signal indicates the second mode.

A region where each of the plurality of first electrodes does not overlap the second electrodes may be wider than a region where each of the plurality of first electrodes overlaps the second electrodes.

The switching block may further include a third switching unit. The third switching unit may be connected between the first switching unit and the second switching unit. The third switching unit may be configured to connect the first electrodes disposed on one side of the first row and the first electrodes disposed on another side of the first row with one another.

According to an aspect of the present inventive concept, there is provided a touch sensing device. The touch sensing device includes a first electrode array, a plurality of second electrodes, and a third electrode. The first electrode array includes a plurality of first electrodes. The plurality of second electrodes is disposed apart from the first electrode array in a direction perpendicular to rows and columns of the first electrode array and arranged in a direction parallel to the rows of the first electrode array. The third electrode is disposed apart from the first electrode array in an opposite direction to the plurality of second electrodes. When the touch sensing device is in a first mode, the touch sensing device senses a touch based on a variation in capacitance between at least one of the plurality of first electrodes and at least one of the plurality of second electrodes. When the touch sensing device is in a second mode, the touch sensing device senses a touch based on a variation in capacitance between at least one of the plurality of first electrodes and the third electrode.

The touch sensing device may further include a switching block. When the touch sensing device is in the first mode, the switching block may be configured to electrically connect a first plurality of adjacent first electrodes of the plurality of first electrodes with one another. The first plurality of adjacent first electrodes may be disposed in a first row of the first electrode array. When the touch sensing device is in the first mode, the touch sensing device may sense a touch based on a variation in capacitance between the first plurality of adjacent first electrodes in the first row and at least one of the plurality of second electrodes.

When the touch sensing device is in the second mode, the switching block may be configured to electrically connect all of the first electrodes in the first row with one another.

When the touch sensing device is in the second mode, the switching block may be configured to electrically connect a second plurality of adjacent first electrodes of the plurality of first electrodes with one another. The second plurality of adjacent first electrodes may be disposed in a first column of the first electrode array. When the touch sensing device is in the second mode, the touch sensing device may sense a touch based on a variation in capacitance between the second plurality of adjacent first electrodes disposed in the first column and the third electrode.

When the touch sensing device is in the second mode, the plurality of second electrodes may be floated or a constant voltage may be applied to the plurality of second electrodes. When the touch sensing device is in the second mode, a constant voltage may be applied to the third electrode.

Each of the plurality of second electrodes may extend in a direction parallel to the columns of the first electrode array.

The touch sensing device may operate in the first mode or in the second mode in response to an externally received signal.

According to an aspect of the present inventive concept, there is provided a touch sensing device. The touch sensing device includes a first electrode array, a third electrode, and a switching block. The first electrode array includes a plurality of first electrodes. The third electrode is disposed apart from the first electrode array in a direction perpendicular to rows and columns of the first electrode array. The switching block is configured to receive a control signal indicating a first mode or a second mode, and to connect a first plurality of adjacent first electrodes of the plurality of first electrodes with one another when the control signal indicates the second mode. The first plurality of adjacent first electrodes is disposed in a first column of the first electrode array. The touch sensing device senses a touch based on a variation in capacitance between the first plurality of adjacent electrodes disposed in the first column and the third electrode when the control signal indicates the second mode.

The touch sensing device may further include a plurality of second electrodes disposed apart from the first electrode array in an opposite direction to the third electrode.

The plurality of second electrodes may be arranged in a direction parallel to the rows of the first electrode array. The switching block may be configured to connect a second plurality of adjacent first electrodes of the plurality of first electrodes with one another when the control signal indicates the first mode. The second plurality of adjacent first electrodes may be disposed in a first row of the first electrode array.

The plurality of second electrodes may be floated or a constant voltage may be applied to the plurality of second electrodes when the control signal indicates the second mode.

### BRIEF DESCRIPTION OF THE DRAWINGS

Exemplary embodiments of the present inventive concept will be more clearly understood from the following detailed description taken in conjunction with the accompanying drawings, in which:

FIG. 1 is a diagram of a touch sensing device according to an exemplary embodiment of the present inventive concept;

FIG. 2 is a top view of the touch sensing device of FIG. 1 according to an exemplary embodiment of the present inventive concept;

FIGS. 3 and 4 are diagrams illustrating operations of the touch sensing device of FIG. 1 according to an exemplary embodiment of the present inventive concept;

FIGS. 5A and 5B are diagrams illustrating operations of the touch sensing device of FIG. 1 in a first mode, according to an exemplary embodiment of the present inventive concept;

FIGS. 6A and 6B are diagrams illustrating operations of the touch sensing device of FIG. 1 in a second mode, according to an exemplary embodiment of the present inventive concept;

FIG. 7 is a block diagram of a touch sensing device according to an exemplary embodiment of the present inventive concept;

FIG. 8 is a diagram of a display device on which a touch sensing device is mounted, according to an exemplary embodiment of the present inventive concept;

FIG. 9 is a diagram of a display device in which a touch sensing device and a display panel are unified, according to an exemplary embodiment of the present inventive concept; and

FIG. 10 is a diagram illustrating various electronic products on which a touch sensing device is mounted, according to an exemplary embodiment of the present inventive concept.

### DETAILED DESCRIPTION OF THE EMBODIMENTS

As used herein, the term “and/or” includes any and all combinations of one or more of the associated listed items.

Hereinafter, the present inventive concept will now be described more fully with reference to the accompanying drawings. The exemplary embodiments of the present inventive concept are shown so that this disclosure will be thorough and complete. This present inventive concept may, however, be embodied in different forms and should not be construed as limited to the embodiments set forth herein. It will be understood that, although the terms first, second, etc. may be used herein to describe various elements, these elements should not be limited by these terms. These terms are only used to distinguish one element from another.

In a capacitance method, which is one of the touch sensing methods applied to a touch sensing device, an approach of an object (hereinafter, referred to as a “pointer”) may be sensed using a variation in an electric field that occurs in response to the approach of the pointer. Thus, a touch sensing device adopting the capacitance method may sense a near touch even if contact is not made. The near touch may be referred to as a proximity touch or a hovering touch, which may be used for various purposes, such as games, gesture recognition, or the like.

In a capacitive touch sensing device, a distance between an outer surface of the touch sensing device and a pointer at which the hovering touch may be sensed (hereinafter, referred to as a “hovering distance”) may be proportional to a magnitude of an electric field formed by an electrode included in the touch sensing device. Thus, the hovering distance in the touch sensing device may increase as an area of the electrode and a voltage applied to the electrode increase.

To reduce power consumption in a mobile electronic device, such as a portable phone, a personal digital assistant (PDA), a laptop computer, a tablet personal computer (PC), or the like, a voltage applied to an electrode of a touch sensing device used in a mobile electronic device may be limited. In addition, resolution of a contact touch may be decreased as the area of the electrode included in the touch sensing device increases, and thus, the area of the electrode of the touch sensing device may be limited. According to an exemplary embodiment of the present inventive concept, a touch sensing device capable of increasing both the hovering distance and the resolution of the contact touch may be provided. In addition, according to an exemplary embodiment of the present inventive concept, a touch sensing device capable of sensing at least two touches (e.g., a multi-touch), which simultaneously occur due to a hovering touch and a contact touch, may be provided.

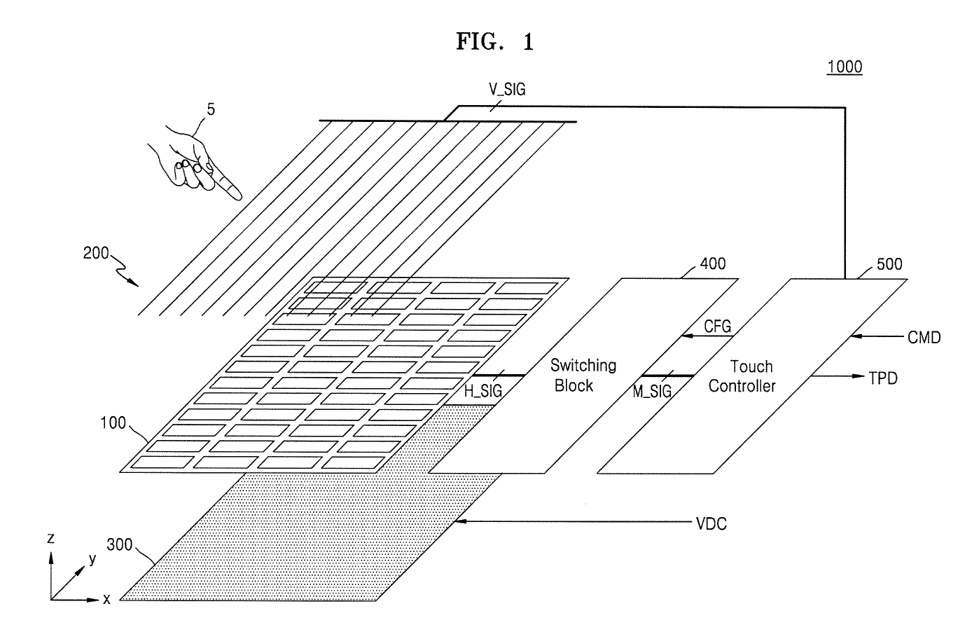

FIG. 1 is a diagram of a touch sensing device 1000 according to an exemplary embodiment of the present inventive concept. Touches of a pointer 5, such as a user's finger, a touch pen, or the like, may be input to the touch sensing device 1000, and the touch sensing device 1000 may output data indicating positions where the touches occur. In addition, the touch sensing device 1000 may receive a command signal from an external device connected to the touch sensing device 1000 and operate based on the received control signal. As shown in FIG. 1, the touch sensing device 1000 may include a plurality of electrodes (for example, a first electrode array 100, a plurality of second electrodes 200, and a third electrode 300), a switching block 400, and a touch controller 500.

The touch sensing device 1000 may include the first electrode array 100, the plurality of second electrodes 200, and the third electrode 300. Each of a plurality of first electrodes included in the first electrode array 100, the plurality of second electrodes 200, and the third electrode 300 may include a transparent conductive material, for example, indium tin oxide (ITO). Although FIG. 1 illustrates a case in which the first electrode array 100, the plurality of second electrodes 200, and the third electrode 300 are spatially spaced apart from one another, the illustration is exaggerated for clarity. For example, the first electrode array 100, the plurality of second electrodes 200, and the third electrode 300 may be disposed adjacent to one another, for example, with thin insulating materials interposed therebetween. In addition, the first electrodes included in the first electrode array 100 and the plurality of second electrodes 200 shown in FIG. 1 may be exaggerated for clarity. In an exemplary embodiment of the present inventive concept, the touch sensing device 1000 may include a greater number of the first electrodes and smaller sizes of second electrodes 200 than those illustrated in FIG. 1.

The first electrode array 100 may include a plurality of first electrodes. The first electrodes may be electrically insulated from one another in the first electrode array 100. The plurality of second electrodes 200 may be disposed apart from the first electrode array 100 in a direction (e.g., +z direction) perpendicular to rows and columns of the first electrode array 100. The plurality of first electrodes included in the first electrode array 100 may be respectively connected to conductive lines exposed outside the first electrode array 100, and the conductive lines may be connected to the switching block 400. Although FIG. 1 illustrates an example in which each of the plurality of first electrodes has a rectangular shape, the present inventive concept is not limited thereto. For example, a plurality of first electrodes, each of which has a shape (e.g., an arrowhead shape) other than a rectangular shape, may be arranged as an array.

Each of the plurality of second electrodes 200 may be arranged in a direction (e.g., x direction) parallel to the rows of the first electrode array 100 and extend in a direction (e.g., y direction) parallel to the columns of the first electrode array 100. As shown in FIG. 1, a pointer 5 may touch the plurality of second electrodes 200 from above. Although not shown in FIG. 1, a window may be disposed above the plurality of second electrodes 200 (e.g., apart from the plurality of second electrodes 200 in the z+ direction) to protect the touch sensing device 1000.

The third electrode 300 may be disposed apart from the first electrode array 100 in an opposite direction (e.g., −z direction) to the plurality of second electrodes 200. According to an exemplary embodiment of the present inventive concept, as shown in FIG. 1, the third electrode 300 may have a plate shape and may be stacked apart from the first electrode array 100. As shown in FIG. 1, a constant voltage VDC (e.g., a ground voltage) may be applied to the third electrode 300. The third electrode 300 may receive the constant voltage VDC from the outside of the touch sensing device 1000 or receive the constant voltage VDC from an internal component (e.g., the touch controller 500) of the touch sensing device 1000. Although not shown in FIG. 1, a display panel of a display device may be disposed below the third electrode 300. In this case, the display panel may be spaced apart from the third electrode 300 in the −z direction.

According to an exemplary embodiment of the present inventive concept, the touch sensing device 1000 may operate in a first or second mode. The first or second mode may depend on a command signal CMD received from the outside of the touch sensing device 1000. The touch sensing device 1000 may sense a touch based on a variation in capacitance between the first electrodes included in the first electrode array 100 and the second electrodes 200 in the first mode (hereinafter, referred to as a line mode). In addition, the touch sensing device 1000 may sense a touch based on a variation in capacitance between the first electrodes included in the first electrode array 100 and the third electrode 300 in the second mode (hereinafter, referred to as a dot mode).

As shown in FIG. 1, the touch sensing device 1000 may include the switching block 400, which is connected to the first electrode array 100, and the touch controller 500. As shown in FIG. 1, the switching block 400 may be connected to the first electrode array 100 through a plurality of conductive lines, and the switching block 400 may transmit or receive a signal H_SIG to or from the first electrode array 100 through the plurality of conductive lines. In addition, the switching block 400 may be connected to the touch controller 500 through a plurality of conductive lines, and the switching block 400 may receive a control signal CFG from the touch controller 500.

According to an exemplary embodiment of the present inventive concept, the switching block 400 may electrically connect some of the plurality of first electrodes included in the first electrode array 100 with one another in response to the control signal CFG received from the touch controller 500. For example, the switching block 400 may electrically connect at least two adjacent first electrodes included in the same row of the first electrode array 100 with one another in response to the control signal CFG. In addition, the switching block 400 may electrically connect at least two adjacent first electrodes included in the same column of the first electrode array 100 with one another in response to the control signal CFG. The switching block 400 may include a plurality of analog switches or an analog multiplexer, which may be controlled in response to the control signal CFG. Operations of the switching block 400 in response to the control signal CFG will be described in detail later.

As shown in FIG. 1, the touch sensing device 1000 may include the touch controller 500, which may be connected to the switching block 400 and the plurality of second electrodes 200. The touch controller 500 may receive a command signal CMD from the outside of the touch sensing device 1000 to set the touch sensing device 1000, generate touch position data TPD including information regarding a position where the pointer 5 touches, and output the touch position data TPD to the outside of the touch sensing device 1000. The touch controller 500 may transmit or receive a signal M_SIG to or from the switching block 400 through the plurality of conductive lines connected to the switching block 400, and transmit or receive a signal V_SIG to or from the plurality of second electrodes 200 through a plurality of conductive lines connected to the plurality of second electrodes 200. The touch controller 400 may analyze the position where a touch occurs, based on the signal M_SIG and/or the signal V_SIG, and generate the touch position data TPD.

According to an exemplary embodiment of the present inventive concept, the touch controller 500 may generate the control signal CFG based on the command signal CMD and transmit the control signal CFG to the switching block 400 through the conductive lines connected to the switching block 400. The touch controller 500 may control operations of the switching block 400 by using the control signal CFG. For example, by using the control signal CFG, the touch controller 500 may control the switching block 400 to electrically connect some of the plurality of conductive lines with one another by which the switching block 400 is connected to the first electrode array 100.

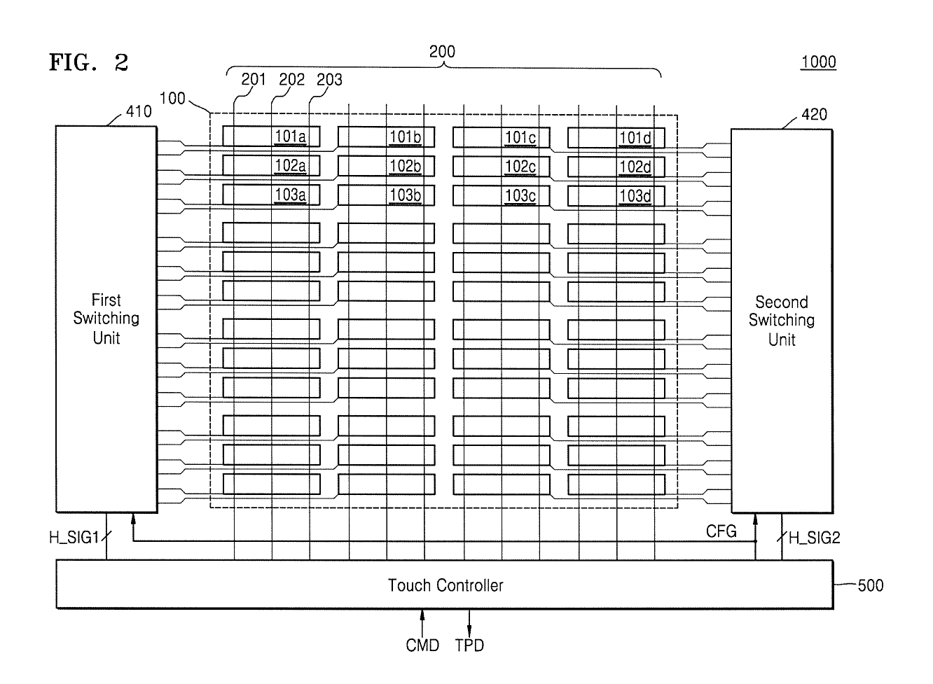

FIG. 2 is a top view of the touch sensing device 1000 of FIG. 1 according to an exemplary embodiment of the present inventive concept. The third electrode 300 of FIG. 1 is not illustrated in FIG. 2 for clarity of description, and first and second switching units 410 and 420 and a touch controller 500 shown in FIG. 2 may be disposed in a different manner than shown in FIG. 2. A first electrode array 100 may include a plurality of first electrodes 101a to 101d, 102a to 102d, and 103a to 103d, which may be arranged as an array and may be respectively connected to a plurality of conductive lines exposed outside the first electrode array 100. As shown in FIG. 2, the first electrodes 101a to 101d, 102a to 102d, and 103a to 103d may be electrically insulated in the first electrode array 100, and each of the conductive lines connected to the first electrodes 101a to 101d, 102a to 102d, and 103a to 103d may be connected to the first switching unit 410 or the second switching unit 420. Second electrodes 200 may include a second electrode 201, 202, or 203 extending in a vertical direction, and the second electrodes may be connected to the touch controller 500. As shown in FIG. 2, the first electrodes 101a to 101d, 102a to 102d, and 103a to 103d of the first electrode array 100 might not overlap the second electrodes 200 as seen in a top view.

Referring to FIGS. 1 and 2, according to an exemplary embodiment of the present inventive concept, the switching block 400 of FIG. 1 may include the first and second switching units 410 and 420. The first switching unit 410 may be electrically connected to first electrodes disposed in one side of rows of the first electrode array 100, and the second switching unit 420 may be electrically connected to first electrodes disposed in another side of the rows of the first electrode array 100. For example, as shown in FIG. 2, the first switching unit 410 may be connected to first electrodes (e.g., first electrodes 101a, 101b, 102a, 102b, 103a, and 103b) included in two columns on a left side of the first electrode array 100 through the conductive lines. In addition, the second switching unit 420 may be connected to first electrodes (e.g., first electrodes 101c, 101d, 102c, 102d, 103c, and 103d) included in two columns on a right side of the first electrode array 200 through the conductive lines.

According to an exemplary embodiment of the present inventive concept, the first switching unit 410 and the second switching unit 420 may be disposed at both ends of the rows of the first electrode array 100. Each of the first switching unit 410 and the second switching unit 420 may be connected to the touch controller 500 through a plurality of conductive lines. The first and second switching units 410 and 420 may respectively transmit or receive a signal H_SIG1 and a signal HSIG2 to or from the touch controller 500 through the conductive lines. In addition, each of the first and second switching units 410 and 420 may receive a control signal CFG from the touch controller 500.

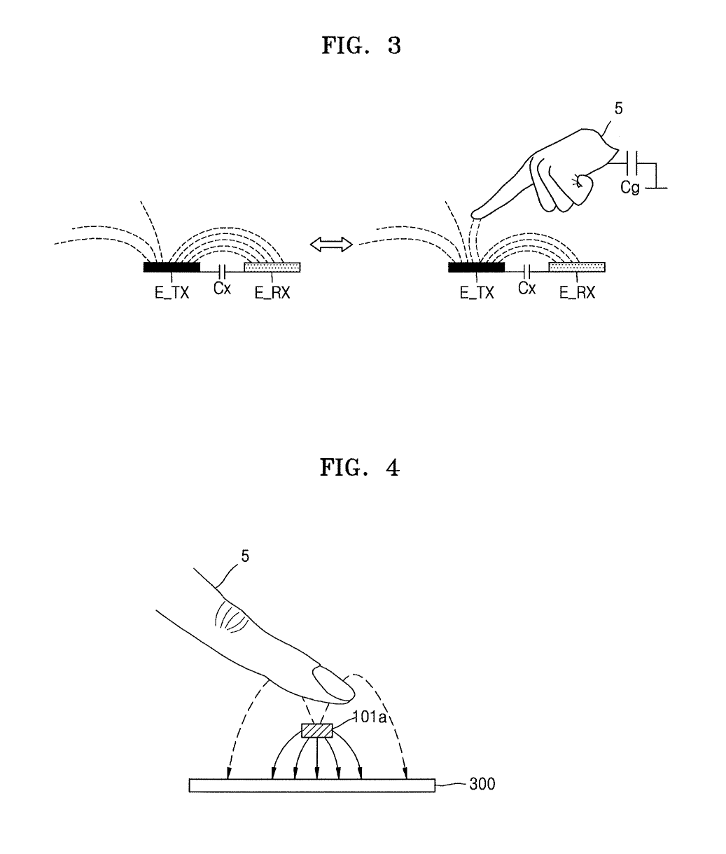

FIGS. 3 and 4 are diagrams illustrating operations of the touch sensing device 1000 of FIG. 1, according to an exemplary embodiment of the present inventive concept. The touch sensing device 1000 as a capacitive touch sensing device may include a mutual-capacitance type touch sensing device or a self-capacitance type touch sensing device. FIG. 3 illustrates operations of the touch sensing device 1000, which use a mutual-capacitance method in a first mode. FIG. 4 illustrates operations of the touch sensing device 1000, which use a self-capacitance method in a second mode.

Referring to FIG. 3, the mutual-capacitance method may be referred to as a line method, and the touch sensing device 1000 may include a sensing electrode E_RX and a driving electrode E_TX. The sensing electrode E_RX may be an electrode for sensing a variation due to a touch of a pointer 5, and the driving electrode E_TX may be an electrode to which a signal having a specific frequency is applied. As shown in FIG. 3, the sensing electrode E_RX and the driving electrode E_TX may be separate from each other, for example, by interposing an insulating material therebetween. A capacitance Cx may be formed between the sensing electrode E_RX and the driving electrode E_TX. Due to an electric signal applied to the driving electrode E_TX, as illustrated with dashed lines in FIG. 3, an electric field may be formed between the driving electrode E_TX and the sensing electrode E_RX.

As shown on the right of FIG. 3, when a touch of the pointer 5 occurs, the electric field between the driving electrode E_TX and the sensing electrode E_RX may vary due to a capacitance Cg of the pointer 5. The touch sensing device 1000 may sense a variation in capacitance Cx between the driving electrode E_TX and the sensing electrode E_RX, and determine a position where the touch of the pointer 5 occurs. Although FIG. 3 illustrates a case in which the driving electrode E_TX and the sensing electrode E_RX are disposed separate from one another in a horizontal direction, the present inventive concept is not limited thereto. For example, the driving electrode E_TX and the sensing electrode E_RX may be disposed as respectively different layers that are separate from each other in a vertical direction (e.g., z direction of FIG. 1). The driving electrode E_TX and the sensing electrode E_RX are disposed to intersect each other, and thus, coordinates (e.g., an x-direction position and a y-directional position of FIG. 1) of the position where the touch occurs may be determined based on positions of the driving electrode E_TX and the sensing electrode E_RX in which the touch occurs.

The above-described mutual-capacitance method may be embodied using a relatively simple structure since it requires a relatively small number of channels for operations. In addition, the mutual-capacitance method may sense a multi-touch occurring due to an object having a relatively small contact area (e.g., the pointer 5). In the mutual-capacitance method, a hovering distance may be relatively short due to a type of electric field formed between the driving electrode E_TX and the sensing electrode E_RX.

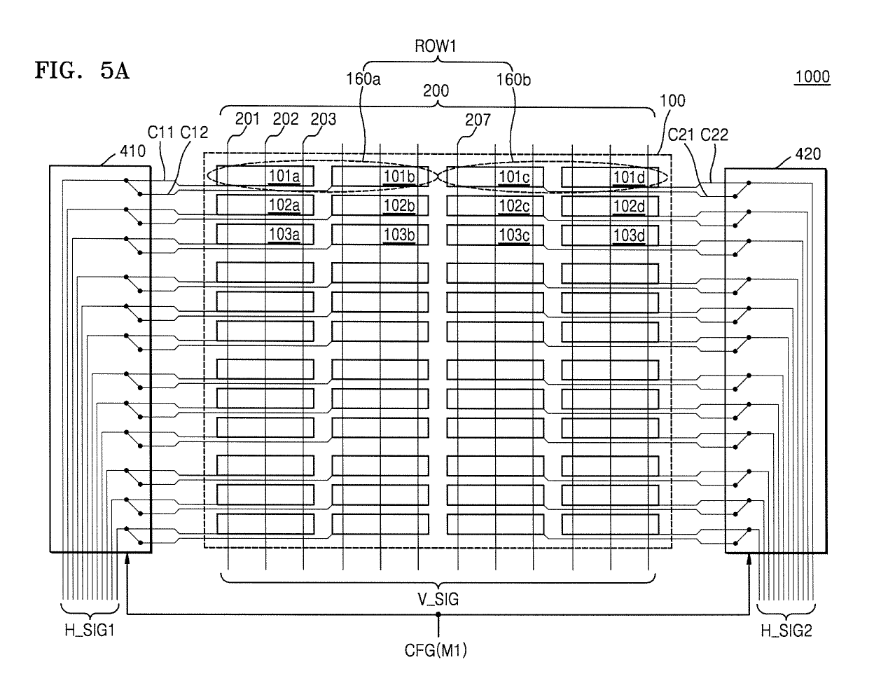

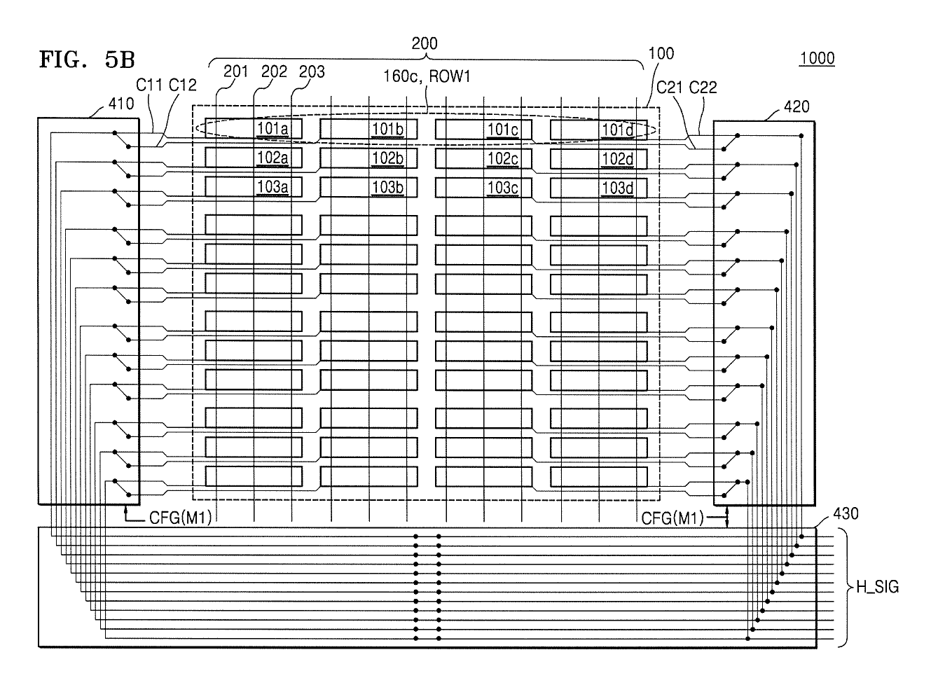

According to an exemplary embodiment of the present inventive concept, the touch sensing device 1000 of FIG. 1 may operate using the mutual-capacitance method in the first mode. Referring to FIGS. 1 through 3, the touch sensing device 1000 may use the first electrodes included in the first electrode array 100 as the sensing electrode E_RX of FIG. 3 and use the second electrodes 200 as the driving electrode E_TX of FIG. 3. According to an exemplary embodiment of the present inventive concept, the touch sensing device 1000 may use the first electrodes included in the first electrode array 100 as the driving electrode E_TX of FIG. 3 and use the second electrodes 200 as the sensing electrode E_RX of FIG. 3. In this case, the switching device 400 of FIG. 1 (or the first and second switching units 410 and 420 of FIG. 2) may electrically connect at least two adjacent first electrodes included in the same row of the first electrode array 100 with one another. Operations of the touch sensing device 1000 in the first mode will be described in detail later with reference to FIGS. 5A and 5B.

Referring to FIG. 4, the self-capacitance method may be referred to as a dot method. The touch sensing device 1000 may determine a position where a touch occurs by sensing a capacitance generated between the pointer 5 and an electrode without applying an additional driving signal to the electrode to sense a touch. When the self-capacitance method is employed, a hovering distance may be relatively long. The self-capacitance method may require a relatively large number of channels for operations.

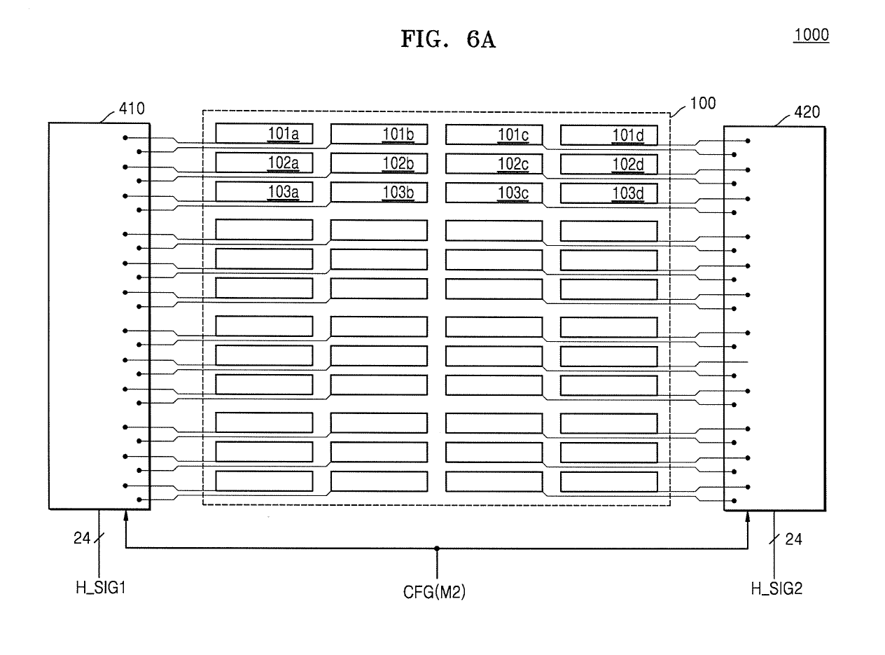

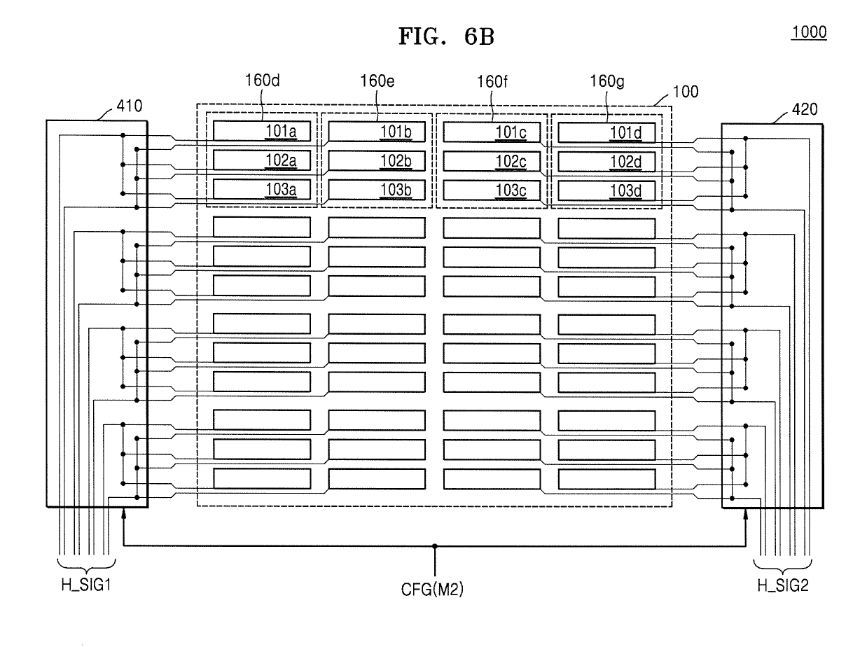

According to an exemplary embodiment of the present inventive concept, the touch sensing device 1000 of FIG. 1 may operate using the self-capacitance method in the second mode. Referring to FIGS. 1, 2, and 4, an electric field may be formed between first electrodes 101a included in the first electrode array 100 and the third electrode 300. As shown in FIG. 4, when the pointer 5 approaches the touch sensing device 1000, the electric field between the first electrode 101a and the third electrode 300 may be changed, and thus, a capacitance between the first electrode 101a and the third electrode 300 may vary. The touch sensing device 1000 may detect a position of the first electrode 101a of which a capacitance varies, and determine a position where a touch occurs. When the touch sensing device 1000 operates in the second mode, a region where the first electrode 101a does not overlap the second electrodes 200 may be wider than a region where the first electrode 101a overlaps the second electrodes 200, and thus, a capacitance in the second mode can vary due to a touch. Operations of the touch sensing device 1000 in the second mode will be described in detail later with reference to FIGS. 6A and 6B.

FIGS. 5A and 5B are diagrams illustrating operations of the touch sensing device 1000 of FIG. 1 in a first mode, according to an exemplary embodiment of the present inventive concept. As described above, in the first mode, the touch sensing device 1000 according to an exemplary embodiment of the present inventive concept may use the first electrodes included in the first electrode array 100 as the sensing electrode E_RX of FIG. 3 and use the second electrodes 200 as the driving electrode E_TX of FIG. 3. In an exemplary embodiment of the present inventive concept, in the first mode, the touch sensing device 1000 may use the first electrodes included in the first electrode array 100 as the driving electrode E_TX of FIG. 3 and use the second electrodes 200 as the sensing electrode E_RX of FIG. 3. To this end, the switching device 400 of FIG. 1 (or the first and second switching units 410 and 420 of FIG. 2) may electrically connect at least two adjacent first electrodes included in the same row of the first electrode array 100 with one another. For clarity of description, the touch controller 500 of FIGS. 1 and 2 is not illustrated in FIGS. 5A and 5B.

FIG. 5A illustrates an exemplary embodiment in which two adjacent first electrodes included in the same row of the first electrode array 100 are electrically connected with one another in the first mode. As shown in FIG. 5A, each of the first switching unit 410 and the second switching unit 420 may receive a control signal CFG(M1) indicating the first mode. Referring to FIG. 2, the touch controller 500 may transmit a control signal CFG(M1) indicating the first mode to the first switching unit 410 and the second switching unit 420 in response to a command signal CMD received from the outside of the touch sensing device 1000.

In response to the control signal CFG(M1) indicating the first mode, the first switching unit 410 and the second switching unit 420 may connect conductive lines with one another, which are respectively connected to the first electrodes of the first electrode array 100,and electrically connect at least two adjacent first electrodes included in the same row of the first electrode array 100 with one another. For example, the first switching unit 410 may electrically connect two adjacent first electrodes 101a and 101b disposed on a left side of a first row ROW 1 of the first electrode array 100 with one another by connecting conducting lines C11 and C12 with one another, which are respectively connected to the first electrodes 101a and 101b, and thus, the first electrodes 101a and 101b may function as an electrode 160a having a larger size than each of the first electrodes. In addition, the second switching unit 420 may electrically connect two adjacent first electrodes 101c and 101d disposed on a right side of the first row ROW1 of the first electrode array 100 with one another by connecting conducting lines C21 and C22 with one another, which are respectively connected to the second 101c and 101d, and thus, the first electrodes 101c and 101d may function as an electrode 160b having a larger size than each of the first electrodes.

Thus, the first switching unit 410 may transmit or receive a signal H_SIG1 to or from the touch controller 500 through twelve conductive lines, and the second switching unit 420 may transmit or receive a signal H_SIG2 to or from the touch controller 500 through twelve conductive lines. Referring to FIG. 3, the touch controller 500 may use the electrodes 160a and 160b having larger sizes than each of the first electrodes as the sensing electrode E_RX and use the second electrodes 200 as the driving electrode E_TX. In an exemplary embodiment of the present inventive concept, the touch controller 500 may use the electrodes 160a and 160b having larger sizes than each of the first electrodes as the driving electrode E_TX and use the second electrodes 200 as the sensing electrode E_RX. In this case, the touch controller 500 may electrically connect some of the second electrodes 200 with one another. For example, since the touch controller 500 may determine whether a touch occurs on the left side or right side of the row using the signal H_SIG1 and the signal H_SIG2, the touch controller 500 may electrically connect a second electrode 201 and a second electrode 207 with each other and reduce the number of channels corresponding to the second electrodes 200.

FIG. 513 illustrates an exemplary embodiment in which all of the first electrodes included in the same row of the first electrode array 100 are electrically connected in the first mode. Referring to FIG. 5B, the switching block 400 of FIG. 1 may include a first switching unit 410, a second switching unit 420, and a third switching unit 430. As described above, the first switching unit 410 may be electrically connected to first electrodes disposed on one side of rows of the first electrode array 100, and the second switching unit 420 may be electrically connected to first electrodes disposed on another side of the rows of the first electrode array 100. The third switching unit 430 may be connected to each of the first switching unit 420 and the second switching unit 420 through a plurality of conductive lines and connect the conductive lines connected to the first switching unit 420 with conductive lines connected to the second switching unit 420. Thus, some of the first electrodes included in the first electrode array 100 may be electrically connected to one another.

As shown in FIG. 5B, each of the first, second, and third switching unit 410, 420, and 430 may receive a control signal CFG(M1) indicating the first mode. The first switching unit 410 and the second switching unit 420 may electrically connect the first electrodes of the first electrode array 100 with one another in response to the control signal CFG(M1) indicating the first mode in a similar manner as described with reference to FIG. 5A, and thus, descriptions of the operations of the first switching unit 410 and the second switching unit 420 will be omitted.

As shown in FIG. 5B, the third switching unit 430 may connect conductive lines corresponding to the same row of the first electrode array 100 with one another, among the conductive lines connected to the first switching unit 410 and the second switching unit 420. Thus, the third switching unit 430 may be connected to the touch controller 500 through twelve conductive lines. For example, the third switching unit 430 may electrically connect the conductive lines C11 and C12 through which the first switching unit 410 is connected to the first electrodes 101a and 101b with the conductive lines C21 and C22 through which the second switching unit 420 is connected to the first electrodes 101c and 101d. Thus, the first electrodes 101a, 101b, 101c, and 101d included in the first row ROW1 of the first electrode array 100 may be electrically connected to one another and function as an electrode 160c having a larger size than each of the electrodes 160a and 160b. Referring to FIG. 3C, the touch controller 500 may use the electrode 160c having a larger size than each of the electrodes 160a and 160b and the second electrodes 200 as the sensing electrode E_RX and the driving electrode E_TX, respectively. In an exemplary embodiment of the present inventive concept, the touch controller 500 may use the electrode 160c having a larger size than each of the electrodes 160a and 160b and the second electrodes 200 as the driving electrode E_TX and the sensing electrode E_RX, respectively.

FIGS. 6A and 6B are diagrams illustrating operations of the touch sensing device 1000 of FIG. 1 in a second mode, according to an exemplary embodiment of the present inventive concept. As described with reference to FIG. 4, the touch sensing device 1000 according to an exemplary embodiment of the present inventive concept may sense a touch using a variation in capacitance of each of the first electrodes included in the first electrode array 100 in the second mode. To this end, the switching block 400 of FIG. 1 (or the first and second switching units 410 and 420 of FIG. 2) may electrically insulate the first electrodes of the first electrode array 100 from one another. For example, the switching block 400 of FIG. 1 (or the first and second switching units 410 and 420 of FIG. 2) might not electrically connect the first electrodes of the first electrode array 100 to one another. According to an exemplary embodiment of the present inventive concept, the switching block 400 of FIG. 1 (or the first and second switching units 410 and 420 of FIG. 2) may electrically connect at least two adjacent first electrodes included in the same column of the first electrode array 100 with one another. The touch controller 500 of FIGS. 1 and 2 is not illustrated in FIGS. 6A and 6B for clarity of description.

Referring to FIG. 1, since the touch sensing device 1000 senses a touch using a variation in capacitance between the first electrodes of the first electrode array 100 and the third electrode 300 in the second mode, the plurality of second electrodes 200 disposed over the first electrode array 100 might not be used in the second mode. According to an exemplary embodiment of the present inventive concept, the touch controller 500 may float the plurality of second electrodes 200 or apply a constant voltage to the plurality of second electrodes 200 in the second mode.

FIG. 6A, illustrates an exemplary embodiment in which the first electrodes of the first electrode array 100 are electrically insulated from one another in the second mode. As shown in FIG. 6A, each of the first switching unit 410 and the second switching unit 420 may receive a control signal CFG(M2) indicating the second mode from the touch controller 500 of FIG. 2.

In response to the control signal CFG(M2) indicating the second mode, the first switching unit 410 and the second switching unit 420 may electrically insulate the first electrodes of the first electrode array 100 from one another. For example, the first switching unit 410 and the second switching unit 420 might not electrically connect the first electrodes of the first electrode array 100 with one another. For example, as shown in FIG. 6A, the first switching unit 410 might not electrically connect 24 first electrodes disposed on a left side of the first electrode array 100 with one another, and the first switching unit 410 may transmit or receive a signal H_SIG1 to or from the touch controller 500 through 24 conductive lines connected to the first electrodes (e.g., 101a, 101b, 102a, 102b, 103a, and 103b) disposed on the left side of the first electrode array 100. In addition, the second switching unit 420 might not electrically connect 24 first electrodes disposed on a right side of the first electrode array 100 with one another, and the second switching unit 420 may transmit or receive a signal H_SIG2 to or from the touch controller 500 through 24 conductive lines connected to the first electrodes (e.g., 101c, 101d, 102c, 102d, 103c, and 103d) disposed on a right side of the first electrode array 100. Thus, the touch sensing device 1000 may determine a position of a touch based on at least one of the first electrodes of the first electrode array 100, of which a capacitance varies due to the touch.

FIG. 6B illustrates an exemplary embodiment in which at least two adjacent first electrodes included in the same column of the first electrode array 100 are electrically connected to one another in the second mode. In the exemplary embodiment shown in FIG. 6A, the first switching unit 410 and the second switching unit 420 may transmit or receive a signal H_SIG1 and a signal H_SIG2 to or from the touch controller 500 through conductive lines which correspond to the first electrodes of the first electrode array 100, respectively. In this case, a high resolution in sensing a touch may be achieved, and a relatively large number of channels may be required. In addition, according to an exemplary embodiment of the present inventive concept, each of the first electrodes of the first electrode array 100 may have an elongated shape in a row direction to support the first mode. Accordingly, at least two first electrodes may be electrically connected to one another in the second mode and constitute an electrode having an appropriate shape for sensing a touch of the pointer 5.

As shown in FIG. 6B, each of the first switching unit 410 and the second switching unit 420 may receive a control signal CFG(M2) indicating the second mode from the touch controller 500 of FIG. 2. In response to the control signal CFG(M2) indicating the second mode, the first switching unit 410 and the second switching unit 420 may electrically connect at least two adjacent first electrodes included in the same column of the first electrode array 100 with one another. For example, as shown in FIG. 6B, the first switching unit 410 may electrically connect adjacent first electrodes 101a, 102a, and 103a included in a first column with one another and electrically connect the first electrodes 101b, 102b, and 103b included in a second column from the first column with one another. In addition, the second switching unit 420 may electrically connect adjacent first electrodes 101c, 102c, and 103c included in a third column and electrically connect first electrodes 101d, 102d, and 103d included in a fourth column. Thus, the first electrodes may function as electrodes 160d, 160e, 160f, and 160g each having a larger size than each of the first electrodes.

For example, the first switching unit 410 may electrically connect three adjacent first electrodes disposed in each of the first and second column of the first electrode array 100 with one another, and thus, eight electrodes each having the three adjacent electrodes may be formed in each of the first and second column. Each of the eight electrodes may have a larger size than each of the first electrodes. Further, the first switching unit 410 may transmit or receive a signal H_SIG1 to or from the touch controller 500 through eight conductive lines, respectively. In addition, the second switching unit 420 may transmit or receive a signal H_SIG2 to or from the touch controller 500 through eight conductive lines which are electrically connected to the electrodes (e.g., 160d, 160e, 160f, and 160g) each having a larger size than each of the first electrodes.

The present inventive concept is not limited to the exemplary embodiments shown in FIGS. 5A to 6B. The present inventive concept may be embodied in various forms. For example, in FIGS. 6A and 6B, the control signal CFG(M2) indicating the second mode may have various values in one format. For example, the touch sensing device 1000 may differently divide the first electrodes of the first electrode array 100 into a plurality of groups in response to the control signal CFG(M2) indicating the second mode and electrically connect the first electrodes of the first electrode array 100 with one another. For example, according to an exemplary embodiment of the present inventive concept, the touch sensing device 1000 may electrically connect the first electrodes with one another in response to the control signal CFG(M2) in the second mode, as shown in FIGS. 6A and 6B. In an exemplary embodiment of the present inventive concept, the touch sensing device 100 may electrically connect a larger number of first electrodes than shown in FIG. 6B with one another.

Thus, referring to FIG. 1, a device (e.g., a processor) configured to receive a user's input through the touch sensing device 1000 may reconstruct the touch sensing device 1000 using a command signal CMD depending on the environment of use. For example, when a user uses a memo function with a touch pen, the processor may transmit a command signal CMD for setting the touch sensing device 1000 to the first mode to the touch sensing device 1000. The touch controller 500 of the touch sensing device 1000 may transmit the control signal CFG(M1) indicating the first mode to the switching block 400 in response to the command signal CMD received from the processor, and the switching block 400 (or the first switching unit 410 and the second switching unit 420 of FIG. 2) may electrically connect the first electrodes of the first electrode array 100 with one another in response to the control signal CFG(M1), as described with reference to FIGS. 5A and 5B.

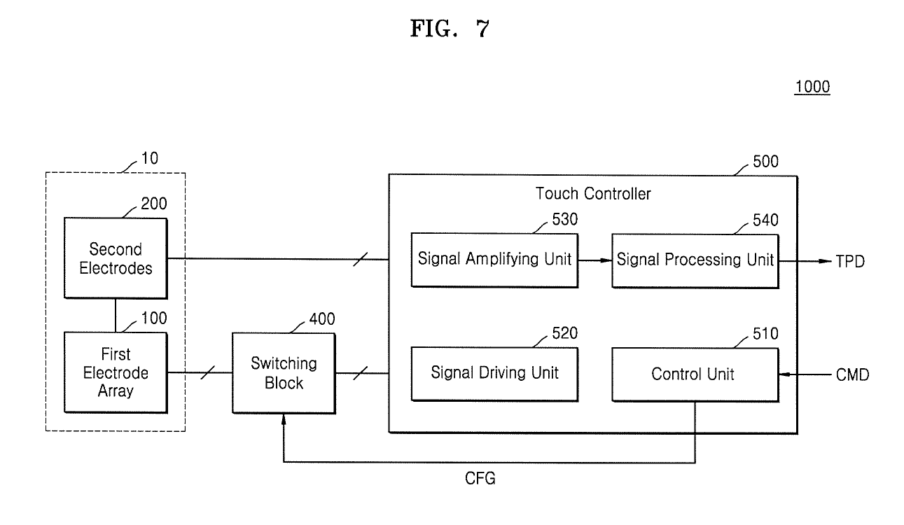

FIG. 7 is a block diagram of a touch sensing device 1000 according to an exemplary embodiment of the present inventive concept. As shown in FIG. 7, the touch sensing device 1000 may include a first electrode array 100, a plurality of second electrodes 200, a switching block 400, and a touch controller 500. The first electrode array 100 and the second electrodes 200 may be included in a sensing region 10 which is configured to sense a user's touch. The first electrode array 100 may be connected to the switching block 400 through a plurality of conductive lines, and the plurality of second electrodes 200 may be connected to the touch controller 500 through a plurality of conductive lines.

The switching block 400 may receive a control signal CFG from the touch controller 500. The switching block 400 (or a first switching unit 410, a second switching unit 420, and a third switching unit 430) may electrically connect the conductive lines with one another or insulate the conductive lines from one another, which are connected to the first electrode array 100, in response to the received control signal CFG, and thus, first electrodes of the first electrode array 100 may be electrically connected to one another or insulated from one another.

As shown in FIG. 7, the touch controller 500 may include a control unit 510, a signal driving unit 520, a signal amplifying unit 530, and a signal processing unit 540. The control unit 510 may receive a command signal CMD from the outside of the touch sensing device 1000, control different components included in the touch controller 500 in response to the received command signal CMD, generate a control signal CFG, and transmit the control signal CFG to the switching block 400.

The signal driving unit 520 may generate a signal for sensing a variation in capacitance due to a touch. The generated signal may be transmitted to the first electrodes included in the first electrode array 100 or the second electrodes 200. For example, referring to FIG. 5B, all of the first electrodes included in the same row of the first electrode array 100 may be electrically connected to one another and function as a driving electrode in a first mode. Thus, the signal driving unit 520 may apply a driving signal to conductive lines connected to the switching block 400. For example, referring to FIG. 5B, when the second electrodes 200 function as a driving electrode, the signal driving unit 520 may apply a driving signal to the conductive lines connected to the second electrodes 200.

The signal amplifying unit 530 may amplify a signal received from the first electrodes included in the first electrode array 100 or the second electrodes 200, and amplify a signal corresponding to a variation in capacitance due to a touch. For example, referring to FIG. 5B, all of the first electrodes included in the same row of the first electrode array 100 may be electrically connected to one another and function as a sensing electrode in the first mode. Thus, the signal amplifying unit 530 may amplify a signal received through conductive lines connected to the switching block 400.

The signal processing unit 540 may receive the signal amplified by the signal amplifying unit 530 and determine a position where a touch occurs, based on the amplified signal. For example, the signal processing unit 540 may determine a position of an electrode of which a capacitance varies due to a touch, based on the amplified signal received from the signal amplifying unit 530. The signal processing unit 540 may process the determined position as data, generate touch position data TPD, and output the touch position data TPD to the outside of the touch sensing device 1000.

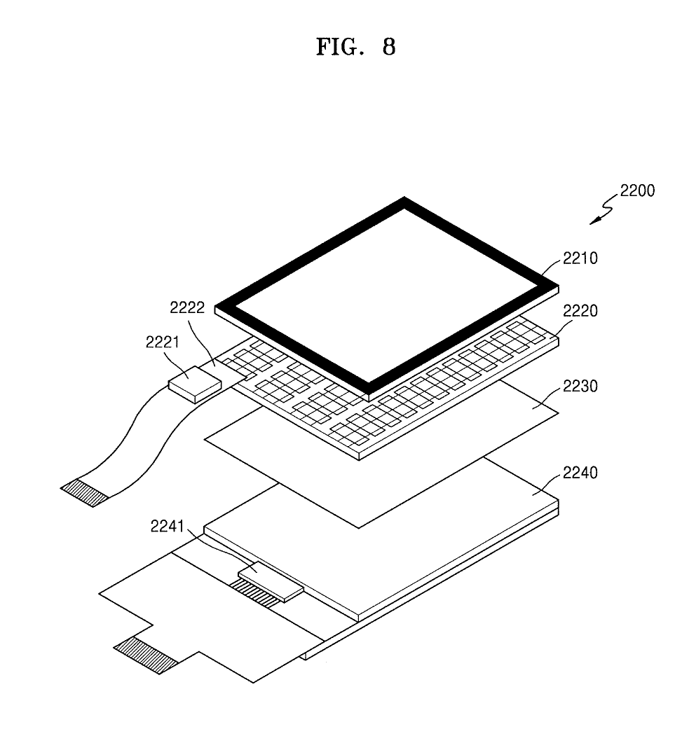

FIG. 8 is a diagram of a display device 2200 on which a touch sensing device 2220 is mounted, according to an exemplary embodiment of the present inventive concept. FIG. 8 illustrates the display device 2200 in which the touch sensing device 2220 is separate from a display panel 2240. As shown in FIG. 8, the display device 2200 may include a window glass 2210, the touch sensing device 2220, and the display panel 2240. In addition, the display device 2200 may further include a polarizer 2230 disposed between the touch sensing device 2220 and the display panel 2240 to realize desired optical characteristics.

The window glass 2210 may be formed of a material, such as acryl, reinforced glass, or the like, and the window glass 2210 may protect the display device 2200 from external impact or damage caused by touches of a user. The touch sensing device 2220 may be formed by patterning a transparent electrode, such as indium tin oxide (ITO), or the like, on a transparent substrate. The transparent substrate may be formed of polyethylene terephthalate (PET), polycarbonate (PC), poly(methyl methacrylate) (PMMA), polyethylene naphthalate (PEN), polyether sulfone (PES), a cyclic olefin copolymer (COC), a triacetyl cellulose (TAC) film, a polyvinyl alcohol (PVA) film, a polyimide (PI) film, polystyrene (PS), biaxially oriented PS (BOPS) (K-resin-containing BOPS), glass, reinforced glass, or the like.

According to an exemplary embodiment of the present inventive concept, the switching block 400 of FIG. 1 may include a first switching unit 410 and a second switching unit 420, as shown in FIG. 2. The first and second switching units 410 and 420 may be disposed opposite to each other on both sides of the touch sensing device 2220. The first switching unit 410 and the second switching unit 420 may electrically connect or insulate some of the first electrodes included in the first electrode array 100 with or from one another in response to a control signal CFG received from a touch controller 2221.

The touch controller 2221 may be mounted as a chip-on-board (COB) type on a flexible printed circuit board (FPCB) and connected to the first and second switching units 410 and 420 disposed on both sides of the touch sensing device 2220, through a plurality of conductive lines. The touch controller 2221 may output touch position data TPD through the FPCB to the outside of the touch sensing device 2220 and receive a command signal CMD from the outside of the touch sensing device 2220.

The display panel 2240 may be formed by bonding two glass plates (e.g., an upper glass plate and a lower glass plate). For example, when the display panel 2240 is used in a mobile device, the display driver circuit 2241 may be adhered as a chip-on-glass (COG) type to the display panel 2240.

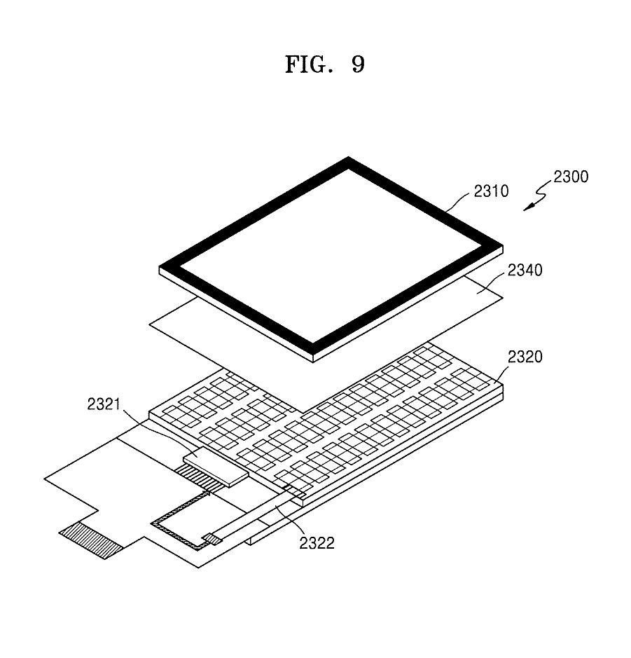

FIG. 9 is a diagram of a display device 2300 in which a touch sensing device and a display panel 2320 are unified, according to an exemplary embodiment of the present inventive concept. As shown in FIG. 9, the display device 2300 may include a window glass 2310, the display panel 2320, and a polaroid 2340. A touch sensing device according to an exemplary embodiment of the present inventive concept might not be formed on an additional glass substrate. For example, the touch sensing device may be unified with the display panel 2320 by patterning a transparent electrode on the upper glass plate of the display panel 2320. In addition, the first and second switching units 410 and 420 shown in FIG. 2 may be formed opposite to each other as a unified type on both sides of the display panel 2320. When the display panel 2320 is produced in the above-described manner, a touch controller and a display driver circuit may be integrated in one semiconductor chip 2321.

When a touch controller and a display driving unit are integrated in a single semiconductor chip 2321, the semiconductor chip 2321 may include a first pad corresponding to touch data and a second pad corresponding to images and gradation data. The semiconductor chip 2321 may be connected to a touch sensing device disposed on the display panel 2320 through conductive lines 2322, and the touch controller integrated in the semiconductor chip 2321 may be connected to a first switching unit, a second switching unit, and second electrodes through the conductive lines 2322.

When pads are disposed on the semiconductor chip 2321, the first pad may be disposed at a position adjacent to the conductive lines 2322 to reduce data noise. Although not shown in FIG. 9, when conductive lines for providing gradation data to the display panel 2320 are disposed on the opposite side to the conductive lines 2322 connected to the touch sensing device, the second pad may be disposed on the opposite side to the first pad.

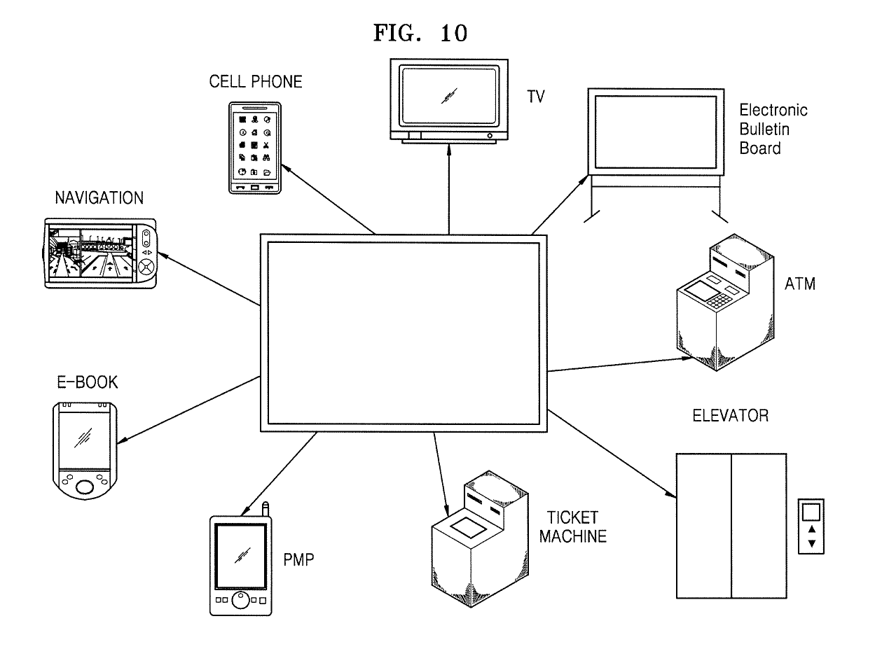

FIG. 10 is a diagram illustrating various electronic products on which a touch sensing device 1000 is mounted, according to an exemplary embodiment of the present inventive concept. The touch sensing device 1000 according to an exemplary embodiment of the present inventive concept may be mounted on various electronic products. For example, the touch sensing device 1000 may be applied to mobile electronic devices, such as a cell phone, a navigation system, an electronic book (e-book) reader, a portable media player (PMP), or the like. The touch sensing device may also be mounted to other electronic devices, such as a ticket dispensing machine, an elevator, an automated teller machine (ATM), or the like. The touch sensing device may also be used in household electronic appliances, such as a TV, an electronic white board, or the like.

While the present inventive concept has been particularly shown and described with reference to exemplary embodiments thereof, it will be understood that various changes in form and details may be made therein without departing from the spirit and scope of the present inventive concept.

What is claimed is:

1. A touch sensing device comprising:
a first electrode array including a plurality of first electrodes;
a plurality of second electrodes disposed apart from the first electrode array in a direction perpendicular to rows and columns of the first electrode array, the plurality of second electrodes being arranged in a direction parallel to the rows of the first electrode array; and
a switching block configured to receive a control signal indicating a first mode or a second mode, and to electrically connect a first plurality of adjacent first electrodes of the plurality of first electrodes with one another when the control signal indicates the first mode, wherein the first plurality of adjacent first electrodes is disposed in a first row of the first electrode array,
wherein the first plurality of adjacent first electrodes overlaps at least one of the plurality of second electrodes.

2. The touch sensing device of claim 1, wherein the switching block is configured to electrically connect a second plurality of adjacent first electrodes of the plurality of first electrodes with one another when the control signal indicates the second mode, wherein the second plurality of adjacent first electrodes is disposed in a first column of the first electrode array.

3. The touch sensing device of claim 1, wherein each of the plurality of second electrodes extends in a direction parallel to the columns of the first electrode array.

4. The touch sensing device of claim 1, wherein the plurality of second electrodes is floated or a constant voltage is applied to the plurality of second electrodes when the control signal indicates the second mode.

5. The touch sensing device of claim 1, wherein the switching block comprises:
a first switching unit configured to electrically connect first electrodes disposed on one side of the first row with one another in response to the control signal; and
a second switching unit configured to electrically connect first electrodes disposed on another other side of the first row with one another in response to the control signal,
wherein the first and second switching units are respectively disposed at both ends of the rows of the first electrode array.

6. The touch sensing device of claim 1, wherein the switching block is configured to electrically connect all of the first electrodes disposed in the first row of the first electrode array with one another when the control signal indicates the first mode.

7. The touch sensing device of claim 1, further comprising a third electrode disposed apart from the first electrode array in an opposite direction to the plurality of second electrodes,
wherein the touch sensing device senses a touch based on a variation in capacitance between the first plurality of adjacent first electrodes disposed in the first row and the at least one of the plurality of second electrodes when the control signal indicates the first mode, and
the touch sensing device senses a touch based on a variation in capacitance between at least one of the plurality of first electrodes and the third electrode when the control signal indicates the second mode.

8. The touch sensing device of claim 1, wherein a region where each of the plurality of first electrodes does not overlap the second electrodes is wider than a region where each of the plurality of first electrodes overlaps the second electrodes.

9. The touch sensing device of claim 5, wherein the switching block further comprises a third switching unit connected between the first switching unit and the second switching unit,
wherein the third switching unit is configured to connect the first electrodes disposed on one side of the first row and the first electrodes disposed on another side of the first row with one another.

10. A touch sensing device comprising:
a first electrode array including a plurality of first electrodes;
a plurality of second electrodes disposed apart from the first electrode array in a direction perpendicular to rows and columns of the first electrode array, the plurality of second electrodes being arranged in a direction parallel to the rows of the first electrode array; and
a third electrode disposed apart from the first electrode array in an opposite direction to the plurality of second electrodes,
wherein the touch sensing device senses a touch based on a variation in capacitance between at least one of the plurality of first electrodes and at least one of the plurality of second electrodes when the touch sensing device is in a first mode, and
wherein the touch sensing device senses a touch based on a variation in capacitance between at least one of the plurality of first electrodes and the third electrode when the touch sensing device is in a second mode.

11. The touch sensing device of claim 10, further comprising a switching block configured to electrically connect a first plurality of adjacent first electrodes of the plurality of first electrodes with one another when the touch sensing device is in the first mode, wherein the first plurality of adjacent first electrodes is disposed in a first row of the first electrode array,
wherein the touch sensing device senses a touch based on a variation in capacitance between the first plurality of adjacent first electrodes and at least one of the plurality of second electrodes when the touch sensing device is in the first mode.

12. The touch sensing device of claim 11, wherein the switching block is configured to electrically connect all of the first electrodes in the first row with one another when the touch sensing device is in the second mode.

13. The touch sensing device of claim 11, wherein the switching block is configured to electrically connect a second plurality of adjacent first electrodes of the plurality of first electrodes with one another when the touch sensing device is in the second mode, wherein the second plurality of adjacent first electrodes is disposed in a first column of the first electrode array, and
wherein the touch sensing device senses a touch based on a variation in capacitance between the second plurality of adjacent first electrodes and the third electrode when the touch sensing device is in the second mode.

14. The touch sensing device of claim 10, wherein the plurality of second electrodes is floated or a constant voltage is applied to the plurality of second electrodes when the touch sensing device is in the second mode, and a constant voltage is applied to the third electrode when the touch sensing device is in the second mode.

15. The touch sensing device of claim 10, wherein each of the plurality of second electrodes extends in a direction parallel to the columns of the first electrode array.

16. The touch sensing device of claim 10, wherein the touch sensing device operates in the first mode or in the second mode in response to an externally received signal.

17. A touch sensing device comprising:
a first electrode array including a plurality of first electrodes;
a third electrode disposed apart from the first electrode array in a direction perpendicular to rows and columns of the first electrode array; and
a switching block configured to receive a control signal indicating a first mode or a second mode, and to connect a first plurality of adjacent first electrodes of the plurality of first electrodes with one another when the control signal indicates the second mode, wherein the first plurality of adjacent first electrodes is disposed in a first column of the first electrode array,
wherein the touch sensing device senses a touch based on a variation in capacitance between the first plurality of adjacent first electrodes and the third electrode when the control signal indicates the second mode.

18. The touch sensing device of claim 17, further comprising a plurality of second electrodes disposed apart from the first electrode array in an opposite direction to the third electrode, wherein the plurality of second electrodes is arranged in a direction parallel to the rows of the first electrode array.

19. The touch sensing device of claim 17, wherein the switching block is configured to connect a second plurality of adjacent first electrodes of the plurality of first electrodes with one another when the control signal indicates the first mode, wherein the second plurality of adjacent first electrodes is disposed in a first row of the first electrode array.

20. The touch sensing device of claim 18, wherein the plurality of second electrodes is floated or a constant voltage is applied to the plurality of second electrodes when the control signal indicates the second mode.
